(19) United States
(12) Patent Application Publication
(10) Pub. No.: US 2005/0170884 A1
(43) Pub. Date: Aug. 4, 2005

(54) Gaming machine, gaming server and gaming system

(75) Inventor: Kazuo Okada, Koto-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 11/008,269

(22) Filed: Dec. 10, 2004

(30) Foreign Application Priority Data
Dec. 12, 2003 (JP) 2003-415130

(51) Int. Cl. A63F 13/00

(52) U.S. Cl. 463/25

(57) ABSTRACT

The present invention provides a gaming machine which allows a player to receive the payout readily even when the player wins a win which requires tax payment, a gaming server which is connected with the gaming machine via a network, and a gaming system which includes the gaming machine and the gaming server. A slot machine which variably displays reels on a liquid crystal display panel, under a control of a main CPU, determines an approval or a disapproval of a win on a combination of symbols stopped on an activated payline for determining the approval/disapproval of the win. When the win is approved, it is determined whether the approved win requires tax payment or not. When it is determined that tax payment is necessary, the main CPU transmits player's personal information and information on an award corresponding to the win which are preliminarily inputted to a gaming server. The gaming server prepares and outputs documents necessary for tax payment based on the received player's personal information and information on the award.

### CROSS-REFERENCES TO THE RELATED APPLICATIONS

This application is based upon and claims the priority from a prior Japanese patent application No. 2003-415130, filed in Japan on Dec. 12, 2003, entire contents of which are incorporated herein by reference.

This application is related to a co-pending U.S. patent application referred to as a prior Japanese patent application No. 2003-412265 filed in Japan on Dec. 10, 2003 and a prior Japanese patent application No. 2004-229883 filed in Japan on Aug. 4, 2004.

### BACKGROUND OF THE INVENTION

1. Field of the Invention

The present invention relates to a gaming machine which pays out an award to a player in response to a win approval/disapproval of a game, a gaming server which is connected with the gaming machine via a network, and a gaming system having the gaming machine and the gaming server.

2. Related Art

Conventionally, as a gaming machine which pays out mediums which are used in a game such as medals, coins or the like (hereinafter referred to as “coins”) corresponding to a content of a win of the game, there has been known a slot machine (for example, see Japanese Laid-open Patent Publication 2000-42169). With respect to the aforementioned slot machine, there has been known a type of slot machine which includes a plurality of reels with symbols attached to outer peripheral surfaces thereof (a mechanical reel) and a type of slot machine which includes a plurality of reels which are displayed by images. In both types of slot machine, when the player performs a predetermined control, the respective reels are rotated or scrolled and, at the point of time that the respective reels are stopped, depending on the combination of symbols of the respective reels which arrive at a predetermined activated payline, whether the player wins in the play (also referred to as “game”) or not and a mode when the player wins the play (winning mode) are determined.

In the slot machine, although the number of coins to be paid out differs depending on the win modes, among these win modes, there exists the win mode which constitutes a big win (big winnings) in which an extremely large number of coins are paid out compared to ordinary payouts. Since the player receives the payout of the large amount of money from the gaming machine when the player wins such big winnings, the player plays a game while expecting the big winnings.

### SUMMARY OF THE INVENTION

However, depending on the country or the region where the gaming machine is installed, there exists legislation which requests a player to pay tax with respect to an amount of money which the player is expected to receive as the payout when the player wins the big win whose payout is equal to or more than a fixed amount (for example, 1200 dollars). In this case, the gaming machine assumes a so-called locked state in which the gaming machine stops its operation without paying out coins. Under this machine-locked state, an attendant arrives at the spot to take procedures such as the preparation of documents necessary for the payment of tax for the player. Accordingly, the conventional gaming machine requires the player to wait for an attendant until he or she receives the award after win, in order to gain the payout (for instance, for about 5 to 10 minutes). It also bothers the player, who wants to receive the payout as soon as possible, in terms of preparation of necessary documents for taxation.

The present invention has been made to overcome the above-mentioned drawbacks and it is an object of the present invention to provide a gaming machine, a gaming server which is connected with the gaming machine via a network, and a gaming system having the gaming machine and the gaming server which allows a player to readily receive the payout even when the player wins a win which requires tax payment.

According to the first aspect of the present invention, there is provided a gaming machine which pays out an award to a player in response to an approval or a disapproval of a win of a game, the gaming machine comprising:
win approval/disapproval determination means which determines the approval or the disapproval of the win; tax payment requirement determination means which determines necessity of tax payment on the win which is approved by the win approval/disapproval determination means; a personal information inputting unit which inputs player's personal information necessary for tax payment corresponding to the award which is determined to require the tax payment by the tax payment requirement determination means; and output means which, when the tax payment requirement determination means determines necessity of the tax payment on the win, outputs information on the award and the player's personal information inputted by the a personal information inputting unit.

According to this invention, in preparation for a case in which the player wins the win which requires tax payment, the player's personal information which becomes necessary at the time of paying tax is preliminarily inputted and hence, when the player wins a win which requires tax payment, the player's personal information is readily outputted to perform the procedure such as the preparation of documents necessary for tax payment. Accordingly, it is possible to identify the player without requesting the player to wait for a long time in front of the gaming machine until an attendant comes whereby the payout of the award corresponding to the win can be readily performed. Further, the gaming machine is locked from the win of the award to the payout of the award. However, the gaming machine of the present invention enables the player or even attendants to terminate the locking more quickly, by speeding up the taxation procedure. The gaming machine can also get back to the normal business.

In this case, it is preferable that the gaming machine includes a selection unit which allows the player to select whether inputting of the player's personal information by the a personal information inputting unit is to be performed or not. Due to such a constitution, the player who wants to prevent his/her personal information from being known to others can refuse the inputting of the information.

Further, it is preferable that the gaming machine includes identification information generating means which generates the player's identification information for recording the player who performs tax payment, and identification information storage means which stores the player's identification information generated by the identification information generating means. Due to such a constitution, it is possible to more reliably perform the identification of the player.

Still further, the gaming machine may preferably be a slot machine.

According to this invention, in the gaming machine which is characterized the payout of the high-amount award to the player such as the slot machine having a plurality of reels on which symbols are attached and are variably displayed, it is possible to speedily perform the procedure such as the preparation of documents necessary for tax payment and hence, it is possible to identify the player without requesting the player to wait for a long time in front of the gaming machine until an attendant comes whereby the award corresponding to the win can be speedily paid out. Further, the gaming machine is locked from the win of the award to the payout of the award. However, the gaming machine of the present invention enables the player or even attendants to terminate the locking more quickly, by speeding up the taxation procedure. The gaming machine can also get back to the normal business.

According to another aspect of the present invention, there is provided a gaming server which is connected with a gaming machine via a network, the gaming server comprising: reception means which receives player's personal information and information on an award corresponding to a win which is transmitted from the gaming machine; tax amount calculation means which calculates a tax payment amount based on the information on the award received by the reception means; and output means which outputs the player's personal information and tax amount information indicative of the tax payment amount which is calculated by the tax amount calculation means.

According to this invention, the gaming server can calculate the tax payment amount based on the player's personal information outputted from the gaming machine without asking for an attendant's help in a gaming arena or the like and can output the tax amount information indicative of the tax payment amount. Accordingly, it is possible to speedily perform the procedure such as the preparation of documents necessary for tax payment and hence, it is possible to identify the player without requesting the player to wait for a long time in front of the gaming machine until an attendant comes whereby the award corresponding to the win can be speedily paid out.

In this case, it is preferable that the gaming server further includes condition determination means which determines a taxation condition for the award based on the player's personal information which is received by the reception means. Due to such a constitution, the confirmation of the taxation conditions on the award by an attendant of a gaming arena or the like becomes no more necessary and hence, the payout of the award can be performed smoothly.

According to another aspect of the present invention, there is provided a gaming system which comprises a gaming machine; and a gaming server connected with the gaming machine, wherein the gaming machine comprises: win approval/disapproval determination means which determines the approval or the disapproval of the win; tax payment requirement determination means which determines necessity of tax payment on the win which is approved by the win approval/disapproval determination means; a personal information inputting unit which inputs player's personal information necessary for tax payment corresponding to the award which is determined to require the tax payment by the tax payment requirement determination means; and output means which, when the tax payment requirement determination means determines necessity of the tax payment on the win, outputs information on the award and the player's personal information inputted by the a personal information inputting unit, and wherein the gaming server comprises: reception means which receives player's personal information and information on an award corresponding to a win which is transmitted from the gaming machine; tax amount calculation means which calculates a tax payment amount based on the information on the award received by the reception means; and output means which outputs the player's personal information and tax amount information indicative of the tax payment amount which is calculated by the tax amount calculation means.

According to this invention, in preparation for a case in which the player wins a win which requires tax payment, the player's personal information which becomes necessary at the time of paying tax is preliminarily inputted from the gaming machine and hence, when the player wins the win which requires tax payment, the player's personal information is readily outputted to the gaming server, and the gaming server can calculate the tax payment amount based on the player's personal information outputted from the gaming machine and can output the tax amount information indicative of this tax payment amount. Accordingly, the procedure such as the preparation of documents necessary for tax payment can be speedily performed and hence, it is possible to identify the player without requesting the player to wait for a long time in front of the gaming machine until an attendant comes whereby the payout of the award corresponding to the win can be readily performed.

According to the above-mentioned inventions, in preparation for the case in which the player wins the win which requires tax payment, the player's personal information which becomes necessary at the time of paying tax can be preliminarily inputted and hence, when the player wins the win which requires tax payment, the player's personal information is readily outputted to perform the procedure such as the preparation of documents necessary for tax payment. Accordingly, the payout of the award corresponding to the win can be readily performed without requesting the player to wait for a long time.

### BRIEF DESCRIPTION OF THE DRAWINGS

FIG. 1 is a perspective view showing the whole constitution of a slot machine which constitutes a gaming machine according to an embodiment of the present invention;

FIG. 2 is a system constitutional view showing the whole constitution of a gaming system according to the embodiment of the present invention;

FIG. 3 is a block diagram of the slot machine which substantially focuses on the inner constitution thereof;

FIG. 4 is a block diagram showing one example of the inner constitution of an image control circuit;

FIG. 5 is a block diagram showing one example of the inner constitution of a gaming server;

FIG. 6 is a flow chart showing operational steps of main processing from a start to an end of a game using the slot machine;

FIG. 7 is a flow chart showing operational steps of lottery processing;

FIG. 8 is a flow chart showing operational steps of tax payment document preparation processing;

FIG. 9 is a flow chart showing steps from the winning of a win to the payout of an award;

FIG. 10 is a flow chart showing steps of preparing tax payment documents using the gaming server;

FIG. 11 is a flow chart showing operational steps of taxation condition determination processing; and

FIG. 12 is a view showing one example of a display content of a player's-information inputting/selection screen.

### DESCRIPTION OF THE PREFERRED EMBODIMENTS

Embodiments of the present invention are explained hereinafter in conjunction with attached drawings. In the drawings, identical or corresponding elements are given same numerals and the overlapped explanation of these elements is omitted.

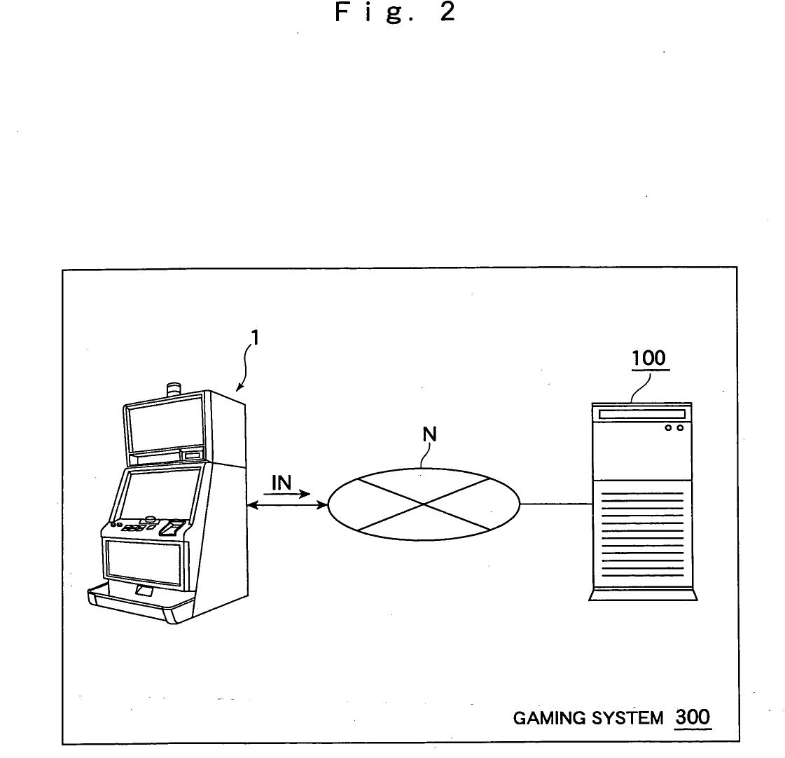

FIG. 2 is a system constitutional view showing the entire constitution of a gaming system 300 according to the embodiment 1 of the present invention. In the gaming system 300, a slot machine 1 and a gaming server 100 are connected via a network N (LAN: Local Area Network or Internet) so that the slot machine 1 and the gaming server 100 can be communicated with each other. This gaming system 300 is configured such that taxation information “In” described later is transmitted to the gaming server 100 from the slot machine 1 via the network N.

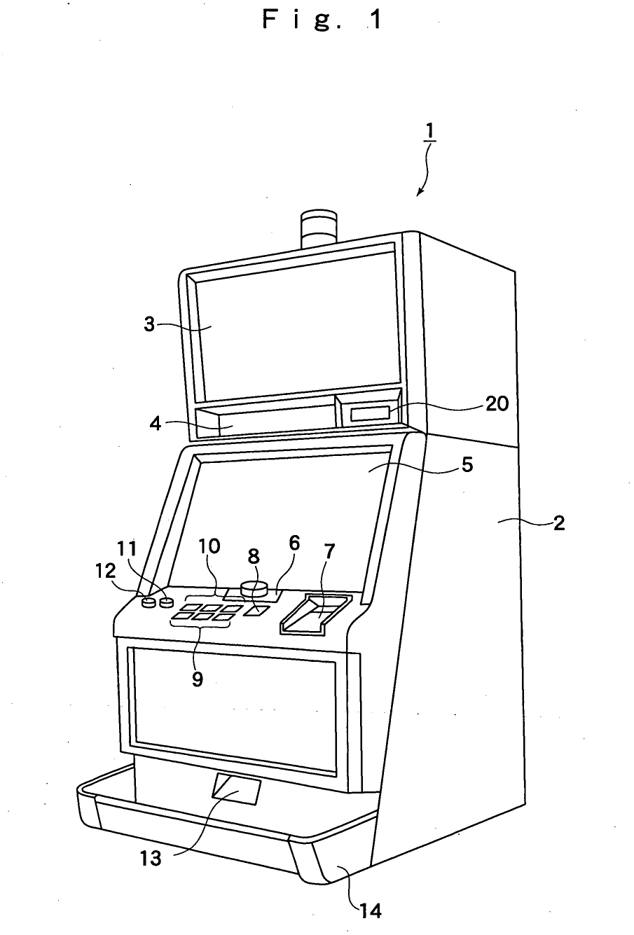

FIG. 1 is a perspective view showing the whole structure of the slot machine 1. The slot machine 1 constitutes a gaming machine according to this embodiment of the present invention and is configured to include variable display means which variably displays a plurality of symbols and displays a plurality of reels on the variable display means so as to allow a player to perform a game. The player determines whether he/she wins a win or not due to the combination of symbols which comes on an activated payline at the point of time that the respective reels are stopped.

In the slot machine 1, liquid crystal display panels 3, 4, 5 are arranged sequentially from above on a front surface of a cabinet 2. On the liquid crystal display panels 3, an image which is not directly relevant to the game (for example, a three-dimensional motion picture for effect or the like which brings the excitement to a game) is displayed. An explanation of the manner of performing the game or the like is displayed on the liquid crystal display panels 4. On a lateral side of the liquid crystal display panel 4, a card insertion opening 20 in which a member card described later is inserted is provided.

On the liquid crystal display panel 5, a plurality of reels are displayed, wherein the respective reels can variably display symbols thereon (including scroll display). Further, the cabinet 2 is provided with a coin payout opening 13 and a coin tray 14 which accommodates paid-out coins on a bottom portion thereof. Here, a plurality of reels may actual reels which have symbols attached to outer peripheral surfaces thereof or may be virtual reels which are displayed by images.

Further, the cabinet 2 is provided with a coin insertion slot 6 for allowing inserting of coins and a bill insertion opening 7 for allowing inserting of bills for betting on the game on a lower side of the liquid crystal display panel 5 thereof. Further, a spin button 8, a BET selection button 9, a line selection button 10, a stop button 11 and a payout button 12 are arranged on the cabinet 2 in the leftward direction from the bill insertion opening 7.

The spin button 8 is provided for inputting a start signal, wherein the player instructs the starting of the game with a control input of the player so as to start the variable display of the reels on the liquid crystal display panel 5. The BET selection button 9 serves to allow the player to input a BET selection signal for selecting and setting the number (for example, one coin, two coins, ten coins) of coins which become subjects of BET. The line selection button 10 serves to allow the player to input a payline selection signal for selecting and setting a desired activated payline from a plurality of activated paylines not shown in the drawing with a control input of the player. A stop button 11 serves to input a stop signal which instructs the stop of the reel on which a variable display is performed. A payout button 12 serves to allow the player to perform a switching control between a credit of the coins that the player has acquired and the payout of the coins. That is, when the credited coins exist, the player inputs a payout signal to pay out the coins.

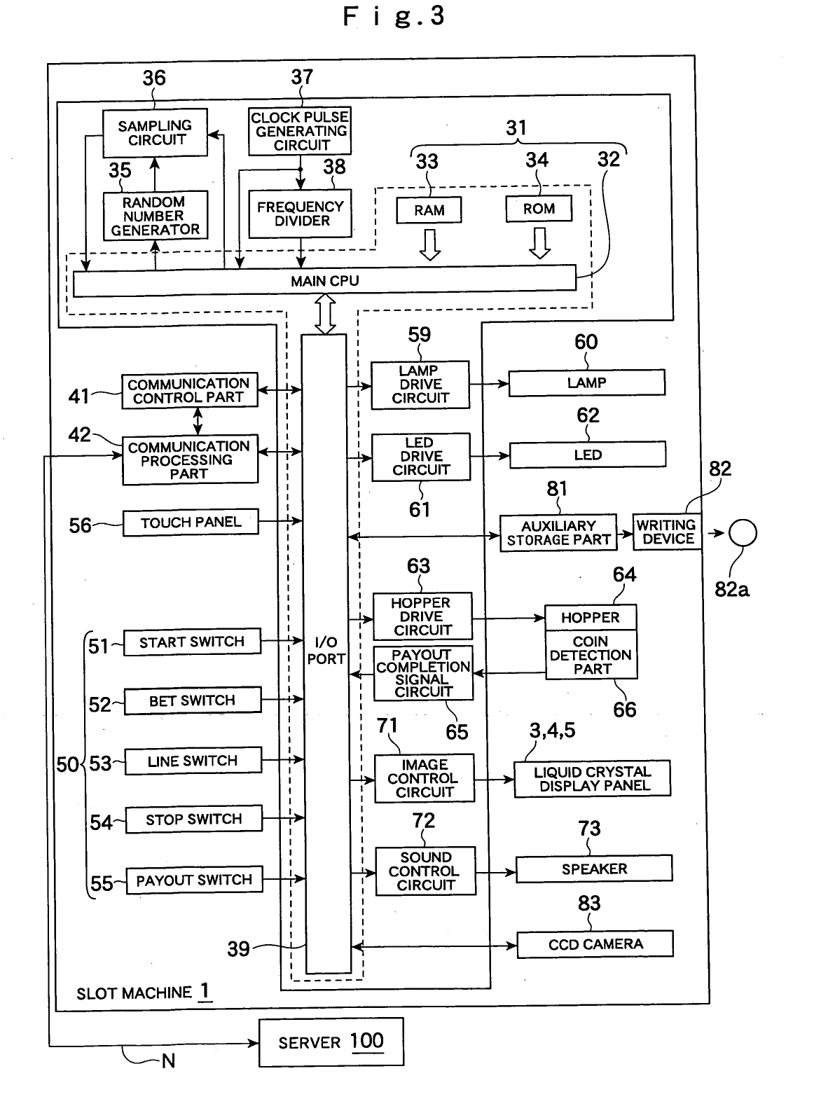

FIG. 3 is a block diagram of the slot machine 1 by focusing on the inner constitution thereof. The slot machine 1 includes a plurality of constitutional elements in which a microcomputer 31 constitutes a main constitutional element.

The microcomputer 31 includes a main CPU (Central Processing Unit) 32, a RAM (Random Access Storage) 33, and a ROM (Read Only Storage) 34. The main CPU 32 is operated in accordance with a program stored in the ROM 34, performs the inputting/outputting of signals with respect to other constitutional elements via an I/O port 39, and performs an operational control of the whole slot machine 1. Data and programs which are used at the time of operating the main CPU 32 are stored in the RAM 33. For example, random number values which are sampled by a sampling circuit 36 described later are temporarily held after starting the game and, at the same time, data including code numbers, symbol numbers and the like of the reels are stored. In the ROM 34, a program which the main CPU 32 executes and permanent data are stored. In the ROM 34 of this embodiment, a win determination table, a symbol determination table, a stop table and a payout table which are described later are stored.

Further, the slot machine 1 includes a random number generator 35, a sampling circuit 36, a clock pulse generating circuit 37, and a frequency divider 38. The random number generator 35 is operated in accordance with an instruction from the main CPU 32 and generates random numbers within a predetermined range. The sampling circuit 36, in accordance with the instruction from the main CPU 32, samples arbitrary random numbers out of the random numbers generated by the random number generator 35 and inputs the sampled random numbers to the main CPU 32. The clock pulse generating circuit 37 generates a reference clock for operating the main CPU 32, while the frequency divider 38 inputs signals obtained by dividing the frequency of the reference clock at a fixed cycle to the main CPU 32.

Further, the slot machine 1 includes a communication control part 41 and a communication processing part 42. The slot machine 1 also includes a switch input unit 50 and a touch panel 56.

The communication control part 41 is operated in accordance with an instruction from the main CPU 32 and controls the connection and disconnection of the communication with the gaming server 100. The communication processing part 42 is communication means which is operated in accordance with an instruction from the communication control part 41 and executes the transmission/reception of data performed via the network N. The communication processing part 42 is operated as the transmission means which transmits the player's personal information and the information on award described later to the gaming server 100.

The switch input unit 50 includes a start switch 51, a BET switch 52, a line switch 53, a stop switch 54 and a payout switch 55. The start switch 51 inputs a start signal to the main CPU 32 upon detection of a control input of the spin button 8. The BET switch 52 inputs a BET selection signal to the main CPU 32 upon detection of a control input of the BET selection button 9. The line switch 53 inputs a payline selection signal to the main CPU 32 upon detection of a control input of the line selection button 10. The stop switch 54 inputs a stop signal to the main CPU 32 upon detection of a control input of the stop button 11. The payout switch 55 inputs a payout signal to the main CPU 32 upon detection of a control input of the payout button 12.

A touch panel 56 is provided in a state that the touch panel 56 covers a display screen of the liquid crystal display panel 5, wherein the touch panel 56 detects a position of a portion where a finger of the player touches and inputs a position signal corresponding to the detected position to the main CPU 32.

Further, the slot machine 1 includes a lamp drive circuit 59, a lamp 60, an LED drive circuit 61, an LED 62, a hopper drive circuit 63, a hopper 64, a payout completion signal circuit 65, and a coin detection part 66. Still further, the slot machine 1 includes an image control circuit 71, a sound control circuit 72 and a speaker 73.

The lamp drive circuit 59 outputs a signal for turning on the lamp 60 to the lamp 60 and blinks the lamp 60 during the performance of the game (for example a second game). Due to this blinking, an effect is obtained. The LED drive circuit 61 controls the blinking display of the LED 62. The LED 62 performs the display of the number of credits, the display of acquired number of coins and the like. The hopper drive circuit 63 drives the hopper 64 in accordance with the control executed by the main CPU 32 and the hopper 64 performs an operation to payout coins so as to payout the coins from the payout opening 13. The coin detection part 66 counts the number of coins paid out from the hopper 64 and informs the payout completion signal circuit 65 of data on the counted number value. The payout completion signal circuit 65 receives the inputting of data of coin number values from the coin detection part 66 and inputs a signal which informs the payout completion of the coins to the main CPU 32 when the number value reaches the set number data.

The image control circuit 71 controls images in the respective liquid crystal display panels 3, 4, 5 and displays various images of the reels or the like which can perform the variable display on the liquid crystal display panels 3, 4, 5.

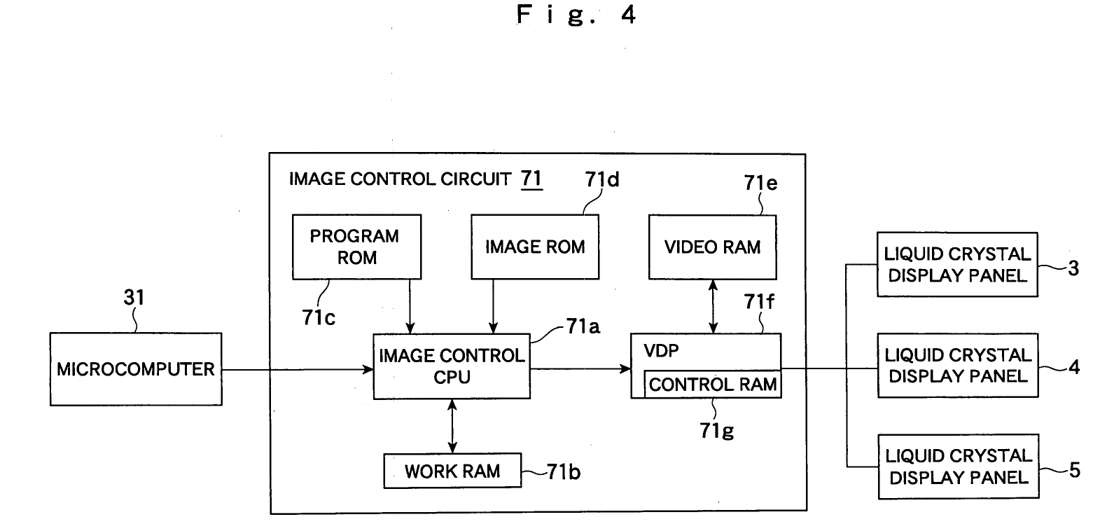

The image control circuit 71, as shown in FIG. 4, includes an image control CPU 71a, a work RAM 71b, a program ROM 71c, an image ROM 71d, a video RAM 71e and a VDP (Video Display Processor) 71f. The image control CPU 71a determines images (reels or the like) which are displayed on the liquid crystal display panels 3, 4, 5 in accordance with an image control program (relevant to the displays on the liquid crystal display panels 3, 4, 5) prestored in the program ROM 71c based on parameters set by the microcomputer 31. The work RAM 71b is constituted as temporary storage means which is used when the image control CPU 71a executes the image control program.

The program ROM 71c stores the image control program, various selection tables and the like. The image ROM 71d stores dot data for forming the images. The video RAM 71e is constituted as temporary storage means which is used for forming images by the VDP 71f. The VDP 71f includes a control RAM 71g and forms images corresponding to display contents of the respective liquid crystal display panels 3, 4, 5 determined by the image control CPU 71a and outputs the respective formed images to the liquid crystal display panels 3, 4, 5.

A sound control circuit 72 inputs vocal signals for outputting voices from a speaker 73 in the speaker 73. Sounds which excite the game are outputted from the speaker 73 at suitable times after starting the game, for example.

Further, the slot machine 1 includes an auxiliary storage part 81, a writing device 82 and a CCD camera 83. The auxiliary storage part 81 stores various data (for example, taxation information, player's personal information, player's identification information and the like) which is used in the execution of the game and tax payment processing which features the present invention and is operated as the identification information storage means according to the present invention. The writing device 82 is operated in accordance with an instruction from the main CPU 32. That is, the writing device 82 is operated as output means which reads out and outputs data stored in the auxiliary storage part 81 and writes and stores the outputted data to a storage medium 82a such as a CD-R (Compact Disc Recordable), a CD-RW (Compact Disc Rewritable) or the like. The CCD camera 83 is operated as player's information generating means. That is, the CCD camera 83 takes a picture (records) of a face of the player as described later using a CCD (Charge Coupled Device), generates image data of the photographed face as player's identification information for recording the player and, stores the image data in the auxiliary storage part 81. Here, it is sufficient for the slot machine 1 to generate information which can surely identify the player. Accordingly, besides the CCD camera 83, it may be possible to provide means which records a fingerprint, a vocal print or an iris of the player and generates the player's identification information based on them.

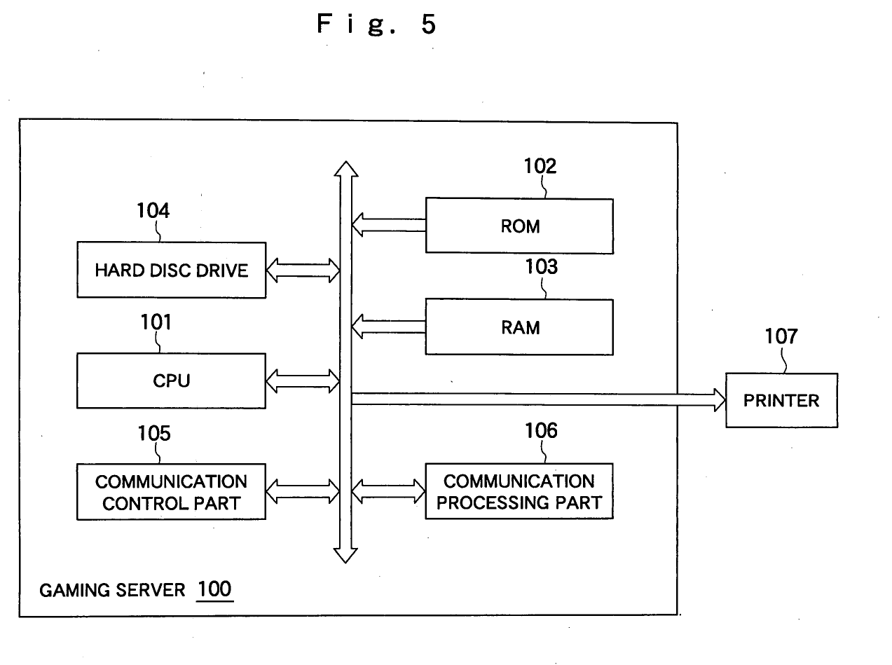

The gaming server 100 includes, as shown in FIG. 5, a CPU 101, a ROM 102, a RAM 103, a hard disc drive 104, a communication control part 105 and a communication processing part 106 and is configured to be communicable with the slot machine 1 via the network N.

The CPU 101 is operated in accordance with a program stored in the ROM 102 and controls an operation of the whole gaming server 100, and is operated as tax amount calculation means which features the present invention. In the ROM 102, a control program which the CPU 101 executes and permanent data are stored. In the RAM 103, data which is used for operating the CPU 101 is stored.

In the hard disc drive 104, data transmitted from the slot machine 1, that is, various data including the player's personal information and the information on the award in this embodiment and the programs are stored. The communication control part 105 is operated in accordance with an instruction from the CPU 101 and controls the connection and disconnection of the communication with the slot machine 1. The communication processing part 106 is operated in accordance with an instruction from the communication control part 105 and executes the transmission/reception of data which are performed via the network N. This communication processing part 106 is operated as reception means which receives the player's personal information and the information on the award from the slot machine 1.

Further, a printer 107 is connected to the gaming server 100 via a LAN or the like, wherein the CPU 101 is operated as means which outputs the player's personal information and the tax amount information described later so as to output data to the printer 107 and the printer 107 prints the inputted data in a predetermined form.

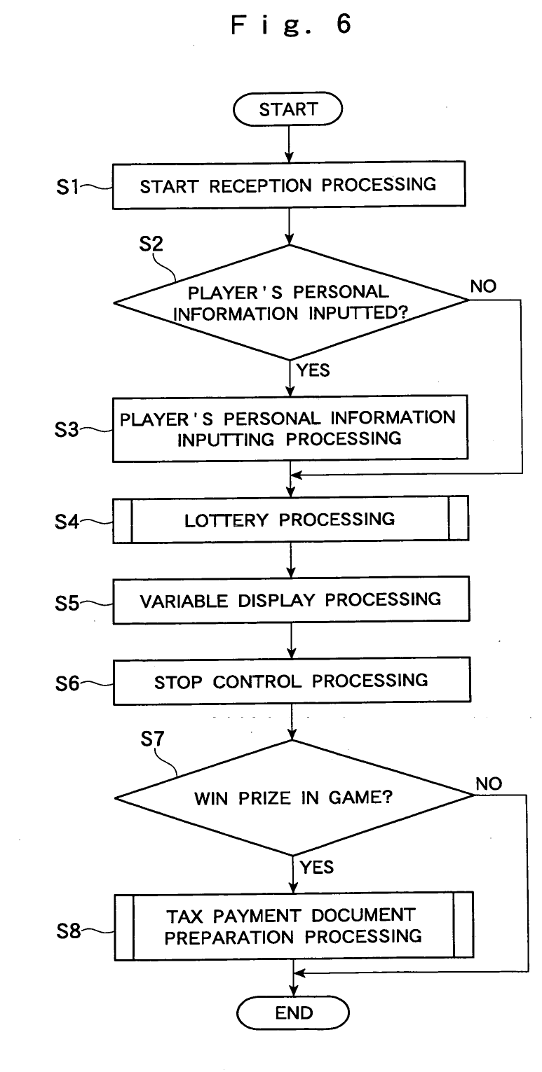

Next, the content of the operation of the gaming system 300 having the above-mentioned constitution is explained in conjunction with flow charts shown in FIG. 6 to FIG. 11. Here, in FIG. 6 to FIG. 11, steps are abbreviated as “S”.

FIG. 6 is the flow chart showing operational steps of main processing from a start to an end of the game performed in the slot machine 1.

As shown in FIG. 6, when the slot machine 1 starts the main processing, at the time of starting the game, the start reception processing is performed in step 1. In the start reception processing in step 1, the slot machine 1 receives an operation for starting the game from the player in accordance with the control from the main CPU 32. The player starts the game. To start the reels (to allow the reels to perform variable display), first of all, the player inserts the number of coins which the player bets in one game into the coin insertion slot 6, sets the number of coins which the player bets in one game by controlling the BET selection button 9 and, further, sets the activated payline by controlling the line selection button 100. Subsequently, the start button 8 is controlled (this control being referred to as “start control” hereinafter). Due to this start control, the start signal is inputted to the main CPU 32 from the start switch 51 (in case of the credit, the BET selection signal is inputted from the BET switch 52).

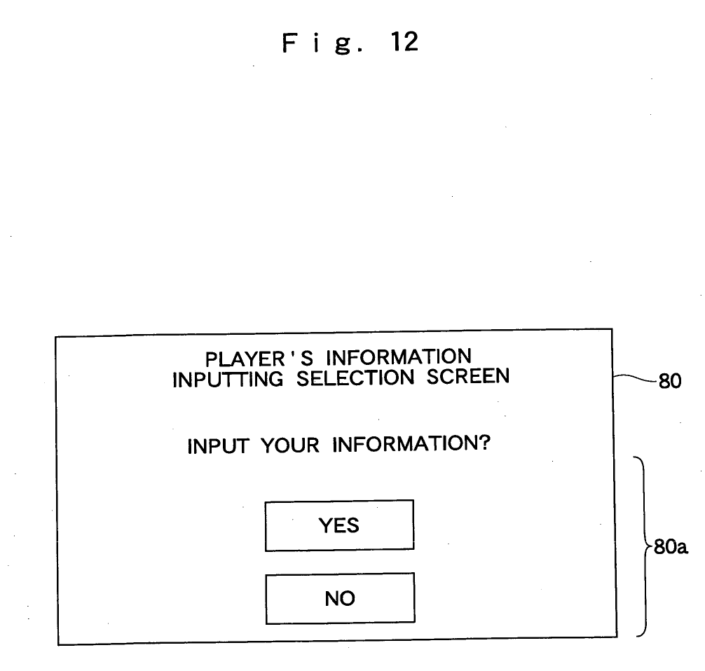

Next, the flow advances to step 2 where the main CPU 32 is operated as selection means and displays a player's information inputting selection screen 80. Here, the player's information inputting selection screen 80 is displayed with a layout shown in FIG. 12, for example. The player's information inputting selection screen 80 includes a display area 80a which display choices whether the player inputs the player's personal information or not. By reference with the player's information inputting selection screen 80, the player selects either one of choices (here, “YES” or “NO”) displayed on the display area 80a and the touches the selected choice with his/her finger. Accordingly, the information which the player selects using the touch panel 56 is inputted to the slot machine 1. In this manner, by allowing the player to select whether the player inputs the player's personal information or not, the player who wants to prevent his/her personal information from being known to others (or recorded) can refuse the inputting of the player's personal information.

When the instruction “The player's personal information is not inputted (selected as “NO”)” is inputted in step 2, the flow advances to step 4. On the other hand, when the instruction “the player's personal information is inputted (“YES”)” is inputted in step 2, the flow advances to step 3 and the inputting of the player's personal information is performed by the player. In inputting the player's personal information in step 3, information such as name, address, birth data, SSN (Social Security Number) and the like of the player is inputted to the slot machine 1. As an inputting method, for example, by touching with his/her finger the input keys not shown in the drawing which are displayed on the liquid crystal display panel 5 which is operated as a personal information inputting unit, the player can input the above-mentioned personal information to the slot machine 1 from the touch panel 56. Further, for example, to a member card (R/W card) not shown in the drawing in which the number of games which have been performed so far and the number of points accumulated corresponding to the number of games can be recorded (can be read and written) the above-mentioned player's personal information is preliminarily recorded. In this case, by inserting this member card into a card insertion opening 20 formed in the slot machine 1 shown in FIG. 1, it is possible to input the player's personal information into the slot machine 1.

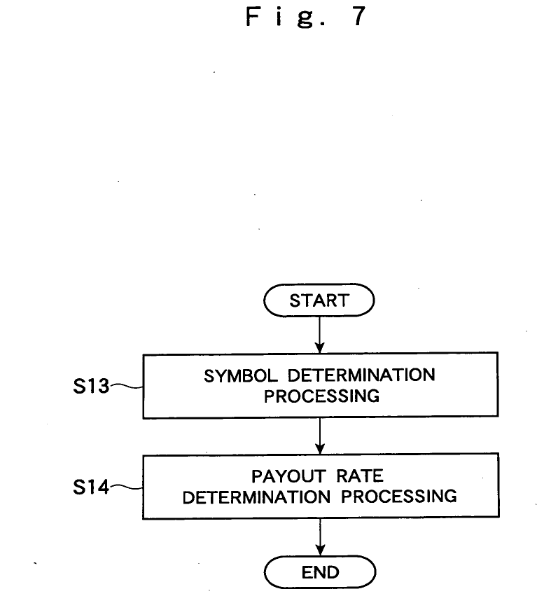

Next, the flow advances to step 4 and the lottery processing is performed. When the lottery processing is started, the flow advances to step 13 shown in FIG. 7 and the symbol determination processing is performed by the main CPU 32. In this symbol determination processing, the main CPU 32 determines the symbols which are stopped at the set activated payline for respective reels.

Then, in the lottery processing, when the main CPU 32 detects the start control of the player in response to an input signal from the start switch 51, instructs the random number generator 35 to generate the random numbers within a predetermined range upon receiving the detection (that is, with this game start as an opportunity). Further, the main CPU 32 instructs the sampling circuit 36 to sample arbitrary random numbers output of the random numbers generated by the random number generator 35. When the random numbers are sampled, the main CPU 32 sets the random numbers in a search key and refers to a symbol determination table (a table which stores code No of symbols and the random numbers in an associated manner) not shown in the drawing which is stored in the ROM 34, and acquires the code numbers of the corresponding symbols.

Next, the acquired code numbers are set in the search key and a stop table (a table which stores the code No of symbols and the symbols in an associated manner) not shown in the drawing is referred and the corresponding symbols are retrieved with respect to respective reels.

Then, in the slot machine 1, the above-mentioned sampling of random numbers and the search of the symbol determination table and stop table are performed for the respective reels. Further, when the symbols are determined with respect to the respective reels, the reel stop positions for stopping the symbols on the activated payline are determined.

Further, the main CPU 32 advances to step 14 and refers to a payout table not shown in the drawing, and determines a payout ratio corresponding to a winning combination. Here, the number of coins to be paid out per one coin corresponding to each winning combination is registered to the payment table. Due to the above-mentioned steps, the lottery processing is finished.

Next, the flow advances to step 5 where the variable display processing is performed. In this case, the image control circuit 71 is operated in accordance with the instruction from the main CPU 32 and game executing images including variable display images of the plurality of reels are displayed on the liquid crystal display panel 5. As a result, on the liquid crystal display panel 5, the plurality of reels are displayed in a variable mode laterally or horizontally at the center thereof thus displaying an activated line which extends laterally at the center thereof (not shown in the drawing). Each reel includes a plurality of symbols and performs the variable display in a state the respective symbols appear one after another in the irregular order.

Here, although not shown in the drawing, it may be possible that the main CPU 32 instructs the image control circuit 71 during the variable display processing such that the liquid crystal display panel 3 displays a three-dimensional image for an effect and the liquid crystal display panel 4 displays images for explaining the method for performing the game and the like.

After the processing in step 5 is finished, the flow advances to step 6 where the stop control processing is performed. Here, the respective reels in a scrolling state are stopped such that the respective reels correspond to a result of the lottery processing in step 2.

Next, the flow advances to step 7 where the main CPU 32 is operated as win approval/disapproval determination means and refers to a win determination table (winning combinations which win the win and winning combinations which do not win the win (non-win) being registered in a distinguishable manner in association with the combination of respective code No (hereinafter also referred to as “code No pattern”)) not shown in the drawing which is stored in the ROM 34, and determines the win approval/disapproval of the game. In the above-mentioned step, the code No pattern corresponding to the stop position of the reel is determined and hence, the win determination table is referred in a state that the code No pattern is set in the search key and the win approval/disapproval is determined based on the result of reference. Here, when it is determined that the win is approved, the flow advances to step 8, while when it is judged that the win is disapproved, the main processing is finished without executing processing in step 8.

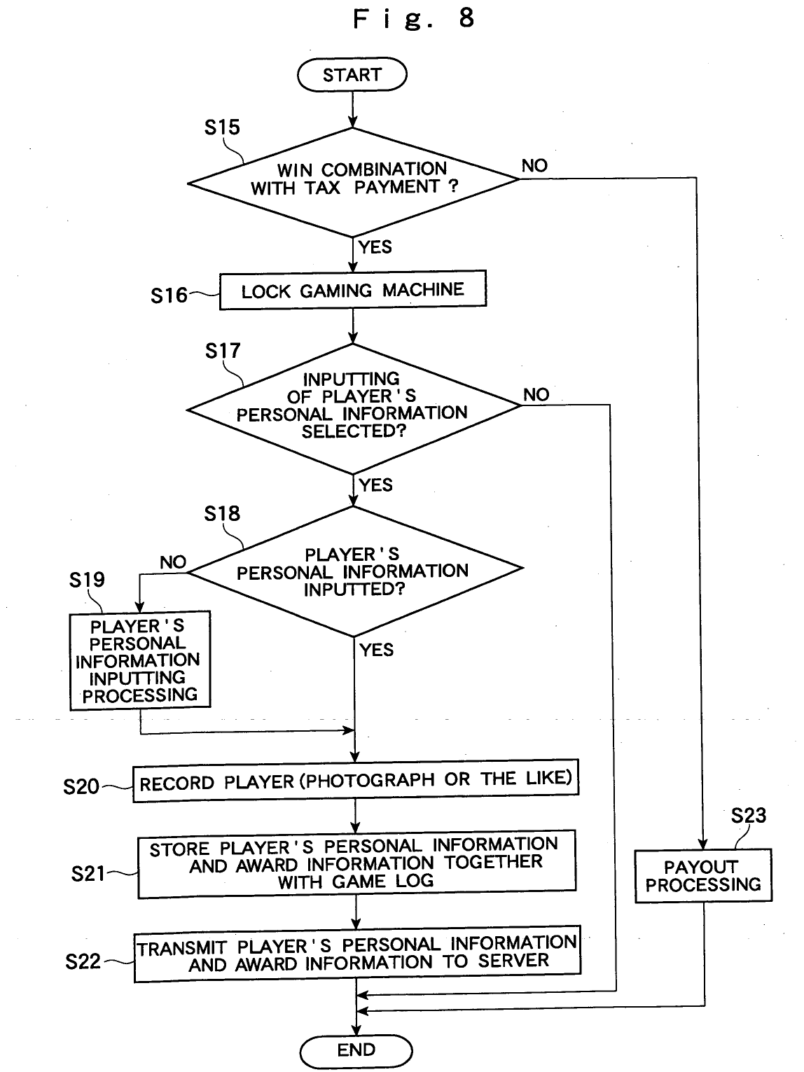

When the flow advances to step 8, the tax payment document preparation processing is started. This processing is performed in accordance with a flowchart shown in FIG. 8.

When the tax payment document preparation processing is started, in step 15, the main CPU 32 is operated as tax payment requirement determination means and determines necessity of tax payment with respect to the win determined by step 5. That is, the main CPU 32 determines whether the win determined by step 5 is the big win and corresponds to the win which becomes the subject of taxation which requires tax payment (hereinafter referred to as “taxation win”) or not. Here, when the win corresponds to the taxation win, the flow advances to step 16 and, while when the win does not correspond to the taxation win, the flow advances to step 23 and the payout processing is performed. In this payout processing, the main CPU 32 instructs a hopper drive circuit 63 to pay out the number of coins corresponding to the award of the win (excluded from taxation) and hence, the coins are paid out from the hopper 64. Further, when the main CPU 32 determines that the number of coins corresponding to the award is paid out in response to a signal from the payout completion signal circuit 65, the main CPU 32 finishes the tax payment document preparation processing whereby the main processing is finished (Here, in this case, the payout may be performed by outputting a ticket with a bar code which records the number of payout coins from a ticket printer not shown in the drawing).

In this embodiment, whether the win corresponds to the taxation win or not is determined based on whether the number of coins to be paid out obtained from the payout table and the award (paid out amount of money) which is determined corresponding to coins which are supplied for BET are equal to or more than fixed values (for example, whether award is 1200 dollars or more when the place where the slot machine 1 is installed of Las Vegas in the State of Nevada, the United States). However, it is needless to say that the present invention is not limited to such conditions.

Subsequently, when the flow advances to step 16, the slot machine 1 assumes the so-called locked state in which the performance of the game is interrupted and, thereafter, the flow advances to step 17. When the flow advances to step 17, it is determined whether the inputting of the player's personal information is selected or not in step 2 shown in FIG. 6. When “The player's personal information is not inputted” is selected, the tax payment document preparation processing is finished. When “The player's personal information is inputted” is selected, the flow advances to step 18.

In step 18, it is determined whether the inputting of the player's personal information is performed or not in step 3 shown in FIG. 6. When the player's personal information is inputted, the flow advances to step 20. On the other hand, when the player's personal information is not inputted in step 3 shown in FIG. 6, the flow advances to step 19 and the inputting of the player's personal information is performed in the same manner as the above-mentioned step 3.

Then, when the flow advances to step 20, the recording processing of the player is performed. Here, in accordance with an instruction from the main CPU 32, the CCD camera 83 is operated as identification information generation means and generates the player's identification information capable of identifying the player. Here, the CCD camera 83 takes a picture of a portion (for example, a face) which can identify the player and generates the image data of the photographed portion as the player's identification information. Further, the CCD camera 83 stores the generated player's identification information in the auxiliary storage part 81. By generating and storing the player's identification information, it is possible to have the information for identifying the player who performs tax payment. This information can be used as the recording of the player who performs tax payment. Accordingly, the identification of the player can be more reliably performed.

Next, the flow advances to step 21 where the main CPU 32 generates the information “In” which contains the player's personal information which is inputted in step 3 or step 19 and the information on the award corresponding to the win (win which requires tax payment) which is determined in step 5, and the main CPU 32 stores and preserves the taxation information “In” in the auxiliary storage part 81 together with the game log indicative of the performance condition of the game. The information “In” which is stored in the auxiliary storage part 81 is read out and outputted by the writing device 82 and is stored in the storage medium 82a when necessary. Further, in accordance with the instruction from the main CPU, the information “In” is read out from the auxiliary storage part 81 and this information “In” is transmitted to the gaming server 100 via the network N by the communication processing part 42 which is operated in accordance with the instruction of the communication control part 41 (step 22). In this manner, it is possible to output the information “In” outside the slot machine 1. Here, the information “In” may be not stored in the auxiliary storage part 81 and may be outputted by transmitting in real time each time the information “In” is generated. Due to the above-mentioned steps, the tax payment document preparation processing is finished and the main processing from the start to the end of the game using the slot machine 1 shown in FIG. 6 is finished.

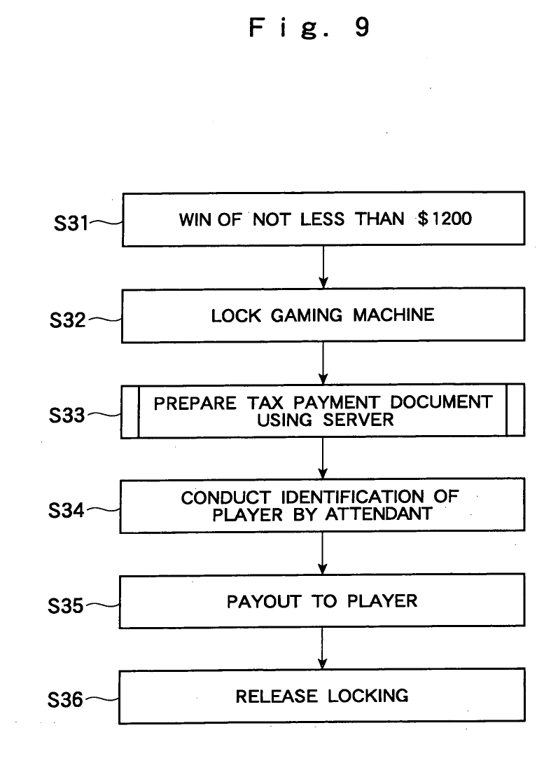

Next, steps from the winning of the win which requires tax payment to the payout of the award to the player and the processing by the gaming server 100 in the process are explained in conjunction with FIG. 9 to FIG. 11. Here, the steps explained hereinafter show steps in the State of Nevada in the United States.

First of all, to explain the steps in conjunction with FIG. 9, as shown in step 31, when the winning of 1200 dollars or more (big winnings) is generated and this turns out to be the win which requires tax payment, as shown in subsequent step 32, the slot machine 1 is locked and, thereafter, as shown in step 33, the tax payment document preparation is performed using the gaming server 100.

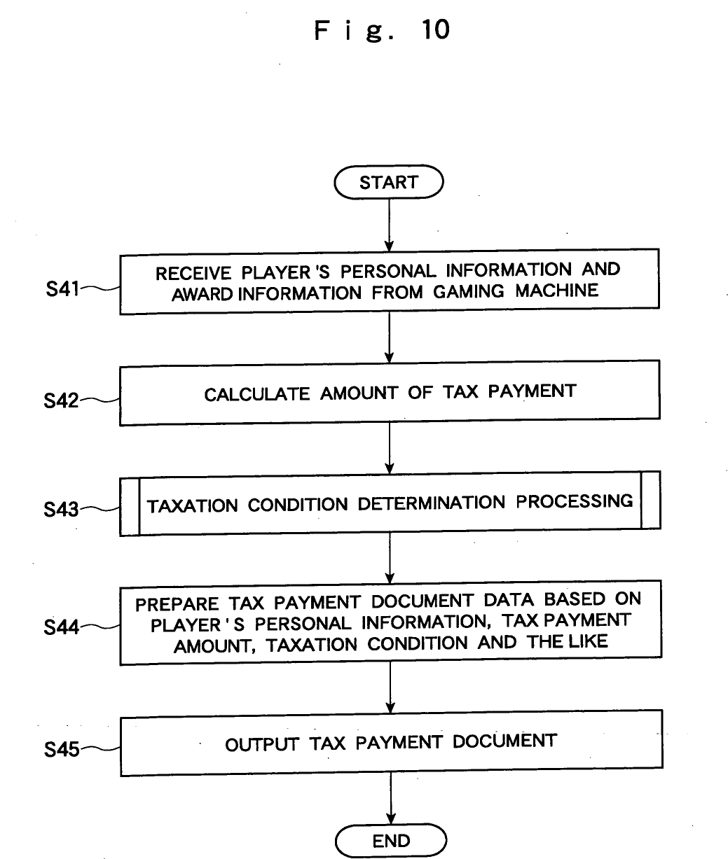

Next, the explanation is made with respect to the preparation of the tax payment document by the gaming server 100 in conjunction with FIG. 10. First of all, as shown in step 41, in the gaming server 100, the communication processing part 106 is operated in accordance with the instruction from the communication control part 105 and receives the player's personal information and the information on the award from the slot machine 1.

Next, the CPU 101 is, as shown in step 42, operated as tax amount calculation means and calculates the tax amount to be paid and the like based on the information on award contained in the information “In”. Here, the CPU 101 obtains, based on the award corresponding to the win which requires tax payment which the player acquires, the tax amount by multiplying the award with a predetermined tax rate and, thereafter, performs the calculation processing to deduct the obtained tax amount from the award to obtain the award after tax.

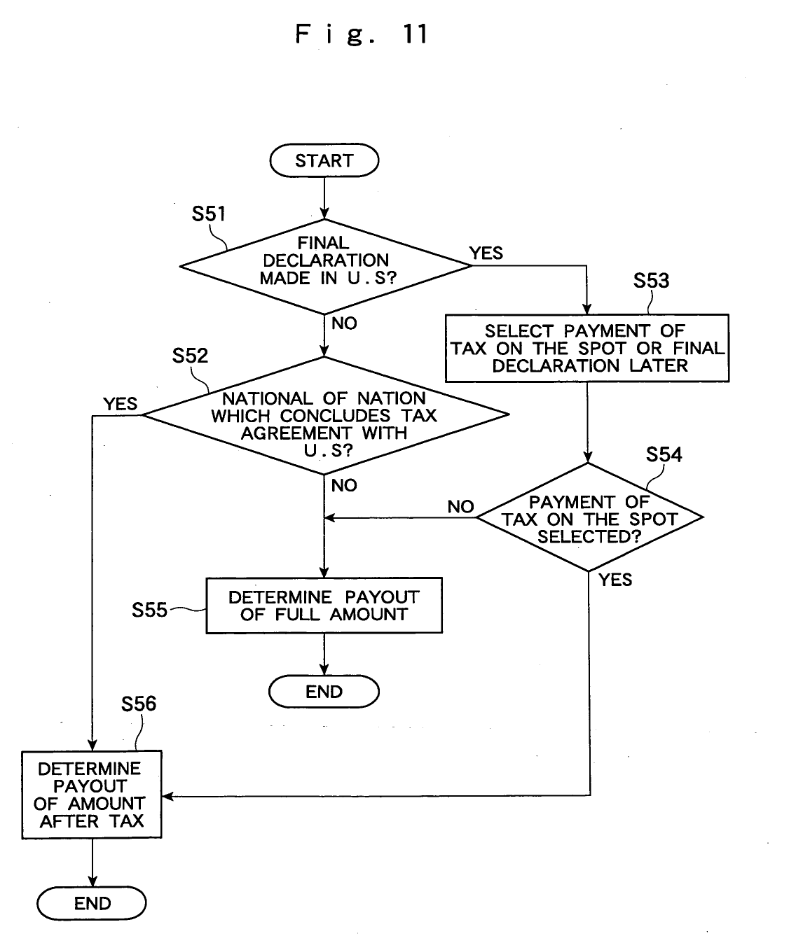

Next, the flow advances to step 43 where the CPU 101 is operated as the condition determination means so as to determine the taxation conditions of the player (taxation condition determination processing). In this taxation condition determination processing, as shown in FIG. 11, in step 51, the processing differs depending on whether the player performs the final declaration in the United States or not. If the player performs the final declaration in the United States, the flow advances to step 53, while if the player does not perform the final declaration in the United States, the flow advances to step 52. When the flow advances to step 52, the processing differs depending on whether the player is a national of a country which concludes a taxation agreement with the United States. When the player is a national of such a country, the flow advances to step 56, while when the player is not a national of such a country, the flow advances to step 55. In step 53, the player selects one of tax payment which pays the tax on the spot (hereinafter referred to “tax payment on the spot”) and tax payment which pays the tax later (hereinafter referred to as “post tax payment”). With respect to the selection of one of these payments by the player, as described in succeeding step 54, when the player selects tax payment on the spot, the flow advances to step 56, while when the player selects the post tax payment, the flow advances to step 55. In step 56, a total amount of award is paid out to the player in step 35 described later. On the other hand, in step 56, an amount corresponding to the award after tax which is obtained by deducting the amount of tax from the award is paid out to the player. Accordingly, the confirmation (determination) operation of the taxation conditions on the award by an attendant of a gaming arena becomes no more necessary and hence, the time necessary for the tax payment procedure can be shortened. Here, the player may select the processing shown in steps 51, 52 on the liquid crystal display panel 5 of the slot machine 1 or input buttons may be provided to the cabinet 2 of the slot machine 1 and the player may select the steps 51, 52 by pushing the input buttons.

When the determination of the tax conditions in step 43 is finished, as shown in step 44, the tax payment document data is prepared based on the tax amount information such as the tax amount to be paid, the award after tax and the like, the player's personal information which is received from the slot machine 1 and the result of the above-mentioned determination of the taxation conditions. Then, as shown in step 54, the CPU 101 outputs the tax payment document data to the printer 107 and the printer 107 prints (outputs) the tax payment documents in a predetermined form based on the tax payment document data. Due to the above-mentioned steps, the processing of the gaming server 100 is finished.

Next, for example, a ticket (for example, a ticket on which a content which certifies that a ticket holder is the player who wins 10000 dollars) is printed out from the slot machine 1 and the player carries the ticket to a casher. Then, as shown in step 34, an attendant of the cash conversion office performs the identification of the player (player identification). This background identification is performed using an identification card with a picture showing the player issued by a public organization (for example, a driver's license, passport or the like) and the attendant collates described matters in the identification card with matters described in the tax payment document. The identification of the player is not limited to the above-mentioned method. For example, the identification of the player may be performed by using image data (player's identification information) which is photographed by the CCD camera 83 or by using the ticket which is printed out from the above-mentioned slot machine 1.

Next, the flow advances to step 35 where the player, referring to the result of the above-mentioned determination of the taxation conditions, receives the payout of the total amount of the award or the amount corresponding to the award after tax which is obtained by deducting the tax amount from the award. Here, the place where the identification of the player and the payout are performed is not limited to the cash conversion office and, for example, an attendant may carry the tax payment documents to the slot machine 1 corresponding to the win and may perform the above-mentioned identification of the player and may hand over the award on the spot. (so-called hand-pay).

Next, the flow advances to step 36 where the locked state of the slot machine 1 is released. This release of the locked state is performed by a remote control from the cash conversion office, for example. Here, the processing for releasing the locking of the slot machine 1 in step 36 may be performed any time during the processing from step 33 to step 35 or may performed during processing of either one of step 33 and step 35.

Due to the above-mentioned processing, the steps from the winning of the win which requires tax payment to the payout of the award to the player are completed. Here, the taxation condition determination processing in step 43 may by performed by an attendant in place of the gaming server 100. That is, the attendant carries the tax payment documents which may be prepared based on the tax amount information and the player's personal information to the slot machine 1 and the attendant may perform the identification of the player and may listen to the player with respect to the taxation conditions.

The slot machine 1 of this embodiment having the above-mentioned constitution, in preparation for a case in which the player wins the win which requires tax payment, the player's personal information which becomes necessary at the time of paying tax can be preliminarily inputted from the slot machine 1. Accordingly, when the player wins the win which requires tax payment, the player's personal information is readily transmitted to the gaming server 100 and the gaming server 100 calculates the tax payment amount based on the player's personal information transmitted from the slot machine 1 and outputs the tax payment information indicative of the tax payment amount. Accordingly, the procedure such as the preparation of documents necessary for tax payment can be readily performed and hence, it is possible to identify the player without requesting the player to wait for a long time in front of the gaming machine whereby the payout of the award corresponding to the win can be readily performed. Further, since the payout to the player can be readily performed, the locked state of the slot machine 1 can be released quickly whereby the operability of the slot machine 1 is enhanced.

Although the present invention has been explained specifically based on the embodiments, the present invention is not limited to the above-mentioned embodiments. For example, although the explanation has been made with respect to the case in which the slot machine is illustrated as the gaming machine which pays out the high-amount award to the player in the above-mentioned embodiment, the mode of the gaming machine is not limited to the slot machine and the present invention is also applicable to a gaming machine of other mode such as a card game.

1. A gaming machine which pays out an award to a player in response to an approval or a disapproval of a win of a game, the gaming machine comprising:
win approval/disapproval determination means which determines the approval or the disapproval of the win;
tax payment requirement determination means which determines necessity of tax payment on the win which is approved by the win approval/disapproval determination means;
a personal information inputting unit which inputs player's personal information necessary for tax payment corresponding to the award which is determined to require the tax payment by the tax payment requirement determination means; and
output means which, when the tax payment requirement determination means determines necessity of the tax payment on the win, outputs information on the award and the player's personal information inputted by the a personal information inputting unit.

2. A gaming machine according to claim 1, wherein the gaming machine includes a selection unit which allows the player to select whether inputting of the player's personal information by the a personal information inputting unit is to be performed or not.

3. A gaming machine according to claim 1, further comprising: identification information generating means which generates theplayer's identification information for recording the player who performs tax payment, and identification information storage means which stores the player's identification information generated by the identification information generating means.

4. A gaming machine according to claim 1, wherein the gaming machine is a slot machine.

5. A gaming server which is connected with a gaming machine via a network, the gaming server comprising:
reception means which receives player's personal information and information on an award corresponding to a win which is transmitted from the gaming machine;
tax amount calculation means which calculates a tax payment amount based on the information on the award received by the reception means; and
output means which outputs the player's personal information and tax amount information indicative of the tax payment amount which is calculated by the tax amount calculation means.

6. A gaming server according to claim 5, wherein the gaming server further includes condition determination means which determines a taxation condition for the award based on the player's personal information which is received by the reception means.

7. A gaming system comprising:
a gaming machine; and
a gaming server connected with the gaming machine, wherein the gaming machine comprises:
win approval/disapproval determination means which determines the approval or the disapproval of the win;
tax payment requirement determination means which determines necessity of tax payment on the win which is approved by the win approval/disapproval determination means;
a personal information inputting unit which inputs player's personal information necessary for tax payment corresponding to the award which is determined to require the tax payment by the tax payment requirement determination means; and
output means which, when the tax payment requirement determination means determines necessity of the tax payment on the win, outputs information on the award and the player's personal information inputted by the a personal information inputting unit, and wherein the gaming server comprises:
reception means which receives player's personal information and information on an award corresponding to a win which is transmitted from the gaming machine;
tax amount calculation means which calculates a tax payment amount based on the information on the award received by the reception means; and
output means which outputs the player's personal information and tax amount information indicative of the tax payment amount which is calculated by the tax amount calculation means.
